(19) United States
(12) Patent Application Publication
(10) Pub. No.: US 2018/0184377 A1
(43) Pub. Date: Jun. 28, 2018

(54) METHOD FOR EXTENDING WUR PACKET TO MULTIPLE DEVICES/TECHNOLOGIES AND ENABLE WUR PACKET AGGREGATION

(71) Applicant: INTEL CORPORATION, SANTA CLARA, CA (US)

(72) Inventors: Thomas J. KENNEY, Portland, OR (US); Minyoung PARK, Portland, OR (US); Shahrnaz AZIZI, Cupertino, CA (US)

(21) Appl. No.: 15/390,054

(22) Filed: Dec. 23, 2016

(51) Int. Cl. H04W 52/02

(52) U.S. Cl. CPC H04W 52/0235; H04W 4/008; H04W 52/028

(57) ABSTRACT

One embodiment is a WUR that not only awakens a Wi-Fi radio in a master device, but also awakens any other radio technology connected to the master device, either directly, or indirectly. These techniques are applicable to any of multiple technologies such as ZigBee, BT, cellular, BLE, Wi-Fi, etc., and in general any wireless communication technology. One embodiment allows one wake-up radio in the master controller to be connected other device(s) within a network, regardless of the radio technology the device(s) use, and allows wake-up of those device(s). One embodiment enables the WUR packet to target device categories/technologies. This extends its use beyond Wi-Fi, and does so in a managed manner which also allows for the WUR payload to be reconfigurable based on the preamble code and/or the information in the first part of the payload, and provides a way to aggregate WUR packets to activate device(s) by a WUR(s).

### TECHNICAL FIELD

An exemplary aspect is directed toward communications systems. More specifically an exemplary aspect is directed toward wireless communications systems and even more specifically to low-power wake-up radios and the associated power management and power savings in one or more wireless systems.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electrical and Electronics Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

ZigBee is an IEEE 802.15.4-based specification for communication protocols used for personal area networks with small, low-power digital radios, such as for home automation, medical device data collection, and other low-power low-bandwidth environments. Some of ZigBee's primary applications, because it is simpler and less expensive than other wireless personal area networks (WPANs), such as Bluetooth® or Wi-Fi, include wireless light switches, electrical meters with in-home-displays, traffic management systems, and other consumer and industrial equipment that requires short-range low-rate wireless data transfer. ZigBee works in the 10-100 meters line-of-sight range, depending on power output and environmental characteristics and ZigBee devices can transmit data over long distances by passing data through a mesh network of intermediate devices to reach more distant ones. ZigBee is typically used in low data rate applications that require long battery life and secure networking (ZigBee networks are secured by 128-bit symmetric encryption keys) with has a defined rate of 250 kbit/s.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary operational environment for the technology discussed herein;

FIG. 2 illustrates an exemplary Low-Power Wake-Up Radio (LP-WUR);

FIG. 3 illustrates a functional block diagram of a wireless device, such as a mobile device;

FIG. 4 illustrates a hardware block diagram of an exemplary wireless device, such as a mobile device;

FIGS. 5-9 illustrate various exemplary embodiments of wake-up packets;

FIG. 10 is a flowchart illustrating an exemplary method for determining and assembling a wake-up packet; and

FIG. 11 is a flowchart illustrating an exemplary method for utilizing a wake-up packet in a master device to control wakeup of one or more slave devices.

### DESCRIPTION OF EMBODIMENTS

Mobile platform power management is one critical aspect of battery-powered small form factor platforms such as smartphones, tablets, wearables, sensors, IoT (Internet of Things) devices, and the like. Most mobile platform workloads are communication driven and the wireless radio is typically one of, if not the, main sources of the platform's power consumption.

Small computing devices such as wearable devices and sensors, mobile devices, Internet of Things (IoT) devices, and the like, are also all constrained by their small battery capacity/size, but still need to support wireless communication technologies such as Wi-Fi, Bluetooth®, Bluetooth® Low Energy (BLE), RFID, and/or the like, or in general any wireless technology/protocol. The wireless connectivity can be used to connect to other computing devices, such as smartphones, tablets, computers, the cloud, the internet, and the like, and exchange data. These communications consume power and it is critical to reduce, minimize or optimize energy consumption for such communications in these devices.

The WUR is a new study group in IEEE. The WUR radio has been studied since 2015 and some basic designs have been proposed. One exemplary embodiment is built upon these basic design concepts, but is expanded and enhanced to enable waking other devices efficiently.

The concept of a Low-Power Wake-Up Receiver/Radio (LP-WUR) was developed as a means to vastly improve the standby, sleep and in cases even active mode power consumption of a wireless device. The underlying technology was introduced to the IEEE 802.11 community in late 2015 as a viable solution to attain substantial power savings for wireless devices. Since then, the LP-WUR has received considerable attention and support which has led to the formation of a Study Group (SG), named Wake-Up Receiver (WUR) SG. The study group has been formed with a charter to study and begin standardization of the WUR as a new amendment to the IEEE 802.11 standards specification. The WUR provides a low-power solution (e.g., ˜50-100 μW in active state) for always-on Wi-Fi (or Bluetooth®) connectivity of wearable, IoT and other emerging devices that will be densely deployed and used in the near future.

The main design has focused on the WUR being utilized in the Wi-Fi channels. It was originally developed based on the IEEE 802.11n/ac channel allocation, which was inefficient from a spectrum utilization perspective since the original WUR design utilized only 4 MHz of the 20 MHz channel. With the introduction of OFDMA in IEEE 802.11ax, the WUR is being designed to be efficiently placed in the smallest OFDMA RU (Resource Unit) of 26 subcarriers (˜2 MHz).

This makes the use of the WUR much more attractive from an overall network perspective.

One main criteria of the design of the WUR is extremely low power and maybe even more importantly low cost. Both of these aspects have been and continue to be of key focus during the development.

Achieving these targets creates a method to have the Wi-Fi radio in a “powered down” or sleep or semi-sleep state affording substantial power savings in typical operational modes. This power saving feature is leveraged and extended to the technology discussed herein, where the WUR is used to not only awake a Wi-Fi radio, but would be able to awake any other radio technology connected to a device/system. By device/system the technology discussed herein can be extended to and is applicable to any device(s)/system(s) that might employ multiple technologies such as a security system which may have ZigBee sensors/actuators, Bluetooth® sensors/actuators, Wi-Fi connectivity for status, streaming etc., and potentially even cellular for, for example, emergency backup on power loss. Additionally, or alternatively, the device could also be a device such as a mobile phone/tablet or computer. Any device/system that would typically utilize multiple technologies is contemplated for this technology. For illustrative purposes the system described herein will be in the security/home automation environment since these systems typically utilize many different technologies. It should be appreciated however that the systems and techniques discussed herein can be extended to any environment and/or device(s).

The exemplary security system can use one wake-up radio in master controller and all the sensors could be connected thereto, regardless of the radio technology the devices use, to the one wake-up radio. Additionally, all signalling to wake-up any device could be done with that radio on that radio's channel. Additionally, a device in the security system that uses multiple technologies (e.g., Wi-Fi and ZigBee), could also only need to add one WUR, instead of one WUR for each devices' technology. This technique further reduces cost/complexity for these devices.

An exemplary embodiment is to enable the WUR to be used to not only awaken a Wi-Fi radio, but in general can be used to awaken any other radio technology connected to a device/system. Again, a device/system refers to any device(s)/system(s) that might utilize multiple technologies such as a security system which may have ZigBee sensors/actuators, Bluetooth® sensors/actuators, RFID components, Wi-Fi connectivity, BLE connectivity, etc., etc., and potentially even cellular communications capability. For ease of explanation the focus herein will be on one use case (while multiple other use cases are certainly possible), with this being the security/home automation since this environment typically utilizes many different communication technologies.

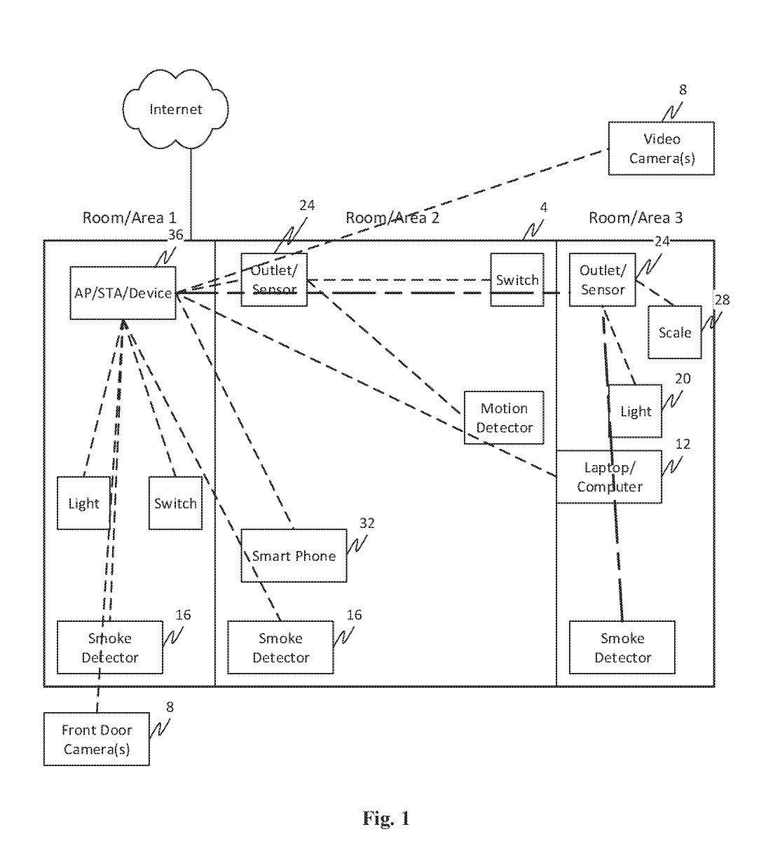

An exemplary home (security) system/automation network/environment is shown in FIG. 1. In this exemplary operational environment, the devices within the structure 4 could be utilizing multiple different technologies. For example, the cameras 8 and laptop 12 could utilize Wi-Fi, the smoke detectors 16, and light bulbs 20 could use ZigBee and the light sensors 24 and weight scale 28 could use Bluetooth®. Additionally, the laptop 12 and smart phone 32 could have Bluetooth®, Wi-Fi and/or cellular connectivity.

An exemplary embodiment allows the security system to only need one wake-up radio in “master controller,” and all the sensors other devices would be connected, regardless of the radio technology the devices use, to the one wake-up radio in the “master controller.” Additionally, all signalling to wake-up any device within the system could be done with the WU radio on the WU radio channel. This further reduces cost/complexity for the systems/devices.

As an example, the AP (Access Point) (which could alternatively be a station (STA) or other device) 36 could include the wake-up radio and serve as the master controller for any one or more other devices, or groups of devices, as shown in FIG. 1.

For any of these devices as shown in FIG. 1, one strategy to minimize energy consumption is to turn the power off to the communication block within the device as much/often as possible while maintaining data transmission and reception capabilities —without a corresponding increase in latency. Ideally the system could power on any of the communications blocks only when there is data to transmit and wake-up the communications blocks just before data reception, and power off the communications blocks (sleep state) for the remainder of the time.

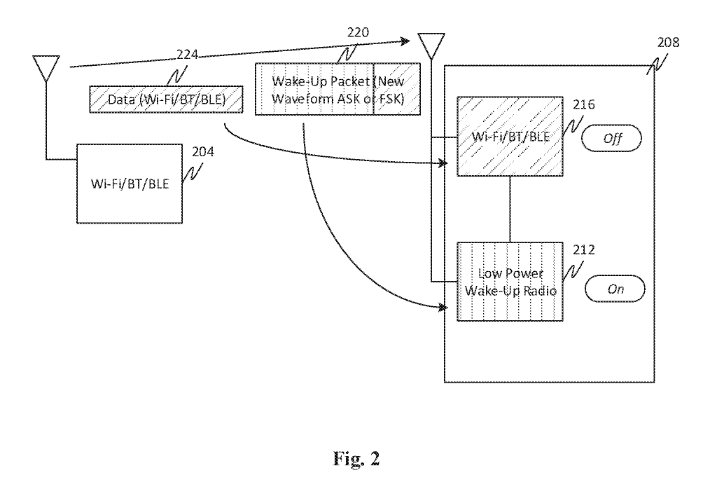

In general, WUR architectures utilize a specially designed low-power (e.g., with ˜50-100 μW active power or less) wake-up radio (LP-WUR) is used along with a main wireless radio (e.g., Wi-Fi, BT (Bluetooth®) and/or BLE (Bluetooth® Low Energy)). Typically, each device has a LP-WUR that switches the “main” radio in the device to wake up only when the main radio has data to receive from another radio (e.g., a Wi-Fi AP), as shown in FIG. 2. For example, when the AP 204 has data to send to the Wi-Fi device 208 (e.g., smartphone), the AP 204 will send a wake-up signal 220 to the LP-WUR 212, which in turn wakes up the main (Wi-Fi/BT/BLE) radio 216 for the data 224.

Use of the low-power wake-up radio (LP-WUR) significantly reduces the power consumption of the main wireless radio(s) (e.g., Wi-Fi, Bluetooth®, LTE, etc.) by removing the need for the main radio to periodically wake up to check if there is data to receive. As shown in FIG. 2, the LP-WUR 212 only requires very low power to operate and to activate the main radio(s) 216. This awakening only occurs when there is data 224 being sent specifically targeting that radio/device 208. The main radio 216 could be any currently known radio, Wi-Fi, Bluetooth®, LTE, 5G, etc., or any future developed radio.

An exemplary target device that can use the proposed technology is a device where a main radio is a radio that is capable of, for example, higher data rates than that of the LP-WUR, and typically consumes more power. This radio will henceforth be referred to as the “main” radio for explanation purposes.

As illustrated in FIG. 2, one way to realize this operational transmit/receive strategy is to have a low-power wake-up receiver/radio (LP-WUR) that can wake-up the main radio, such as a Wi-Fi, Bluetooth® radio, BLE radio, only when there is data to receive. (See FIG. 2 where the Wi-Fi/BT/BLE radio 216 (main radio) is off and the low power wake-up radio 212 is on until data from the AP 204 is received).

When the wake-up packet 220 is received from the AP 204, the LP-WUR 212 wakes-up the Wi-Fi/BT/BLE radio 216, so that a data packet 224 that follows the wake-up packet 220 from the AP 204 can be received correctly. In some cases however, the actual control data can be included in the wake-up packet. In this case, there is no need to wake-up the whole Wi-Fi/BT/BLE radio, but just a portion of the Wi-Fi/BT/BLE radio needs to be woken up to do the necessary processing. This can lead to additional significant power savings.

An exemplary embodiment further enhances the basic LP-WUR operation, which utilizes an extremely low power radio such that a device (such as a wireless device) can be in a listening mode with minimum capability and consume extremely low power, by using one LP-WUP to control the wake-up of one or more additional devices.

Two exemplary approaches discussed herein enable the WUR to be used with all communications technologies. The first approach uses a set of codes as the WUR packet preamble. In this case, each code can identify a different sub-device in the system (i.e., different sensors or other devices in the security network). The codes could also be assigned to a technology that may be in use, e.g., one code for Wi-Fi, one for Bluetooth®, etc. For one exemplary embodiment, the preamble uses one sequence only, however this can be extended to a set of codes/sequences. One exemplary advantage of the approach is using the preamble as an identifier, thus allowing the remainder of the WU packet to be redefined. In general, the contents of the payload can be based on the preamble code. An additionally feature of this approach is that the design can be expanded to have the flexibility to wake more than one radio with one wake-up packet through a WUR packet aggregation. For instance, if the security system needs to wake two sensors for a report, a single WU packet could be used to awaken the two sensors. Having this ability can have the additional benefit of improving network throughput by aggregating the signalling for the wake-up of two devices in one wake-up packet.

The second exemplary approach is to add additional signalling in the WU packet payload. For this approach, an additional few bits could be added to the WU packet payload to identify which device(s) to wake. With this approach, the technology could be again extended to include a mechanism for WUR packet aggregation.

As mentioned previously, one goal of the design of the WUR is extremely low power and low cost. Achieving this target includes a method to have the Wi-Fi radio in a “powered down” state affording substantial power savings in typical operational modes. One exemplary methodology provides a method for the WUR not only awaken a Wi-Fi (or other) radio, but would be able to awaken any other radio technology connected to the device that includes the Wi-Fi radio.

Another exemplary feature associated with this technology is that it allows the system the flexibility to wake more than one radio with one wake-up packet (WUP). For instance, if the security system needs to wake two sensors for a report, a single WU packet can be used. Having this ability improves network throughput by aggregating the signalling of two (or more) devices in one wake-up packet.

Two approaches to enable the WUR to be used with all technologies is outlined. The first is to use a set of codes/sequences as the WUR packet preamble. In this case, each code can identify a different sub-device(s) in the system (i.e., different sensors in the security network). Currently the preamble uses one sequence only—however this would be extended to a set of codes/sequences. The second approach is to add additional signalling in the WU packet payload. In this exemplary approach, additional bit(s) would be added to the WU packet payload to identify which device(s) to wake.

As mentioned, the WUR can be used (or shared) to not only awake a Wi-Fi radio in the device where it is installed, but can also awaken any other radio technology connected to the device. The home system/automation network is shown in FIG. 1. In this case, the various devices depicted in the environment could utilize multiple different communications technologies, with some of the devices possibly employing several of these communications technologies at the same time. As discussed, the cameras and laptop could utilize Wi-Fi, Bluetooth®, cellular and/or near-field communications (NFC) such as RFID. The smoke detector and light bulbs could use ZigBee. The light sensors and weight scale could both use Bluetooth® and/or Z-Wave and/or X10 and/or EnOcean and/or C-bus, or the like. The approach outlined here allows the security system to only need one wake-up radio in the master controller with one or more of the other devices (i.e., slaves), e.g., the sensors, etc., that are connected thereto, regardless of the radio technology the devices use, to utilize and be controlled, e.g., awoken, by the one wake-up radio in the master controller. Additionally, all signalling to wake-up any device could be done through the WUR on the wake-up channel which further reduces cost/complexity for these systems/devices.

One exemplary embodiment accomplishes this by using a technique similar to the above where the WU packet is transmitted on a WU channel to the low power wake up radio tuned to the wake-up channel. Once the LP-WUR(s) receives the WU packet, the WU packet wakes-up the main radio in each device tuned to that wake-up channel.

Two exemplary approaches allow multiple different platforms using multiple different communications technologies to be enabled with one WUR, or a shared WUR packet. The first uses a set of codes in a preamble (of, for example, a wake-up packet), while the second defines a new bit field in the payload of the wake-up packet.

The first exemplary approach uses a set of codes/sequences/information as the WUR packet preamble. In this case, each code will identify a different sub-device(s) in the system (i.e., different sensors in the security network).

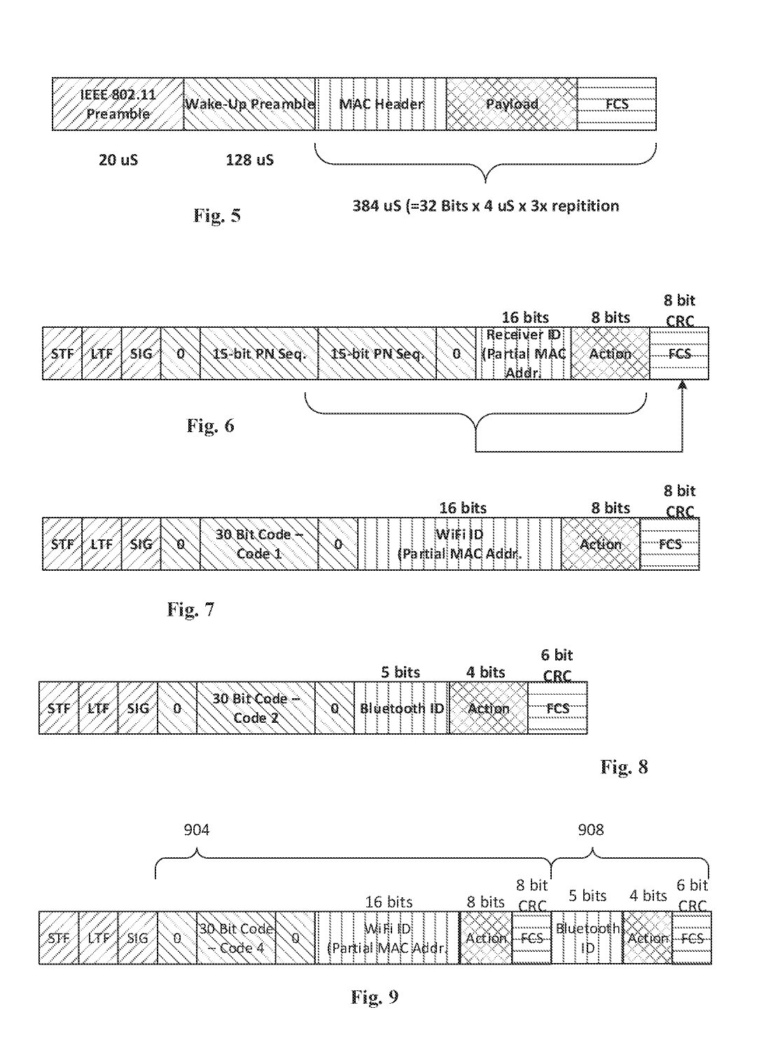

The current frame format for the WUR packet is shown in FIG. 5. The WUR packet includes the legacy Wi-Fi preamble (IEEE 802.11 Preamble), followed by the WUR portion of the packet (Wake-Up Preamble, MAC (Media Access Control) Header, Payload, FCS (Frame Check Sequence)). The IEEE 802.11 Preamble enables other Wi-Fi devices to defer transmission for the Wake-Up Preamble.

Details of the exemplary WUR packet are provided in FIG. 6. As can be seen, there is a legacy portion which includes: STF and LTF and SIG. The STF and LTF fields are similar to the ones used in IEEE 802.11a/g/n/ac. They are a total of 4 symbols and are used for frame identification and front end synchronization. The SIG field is also same as that used in IEEE 802.11a/g/n/ac. SIG describes a data rate and length of the frame in bytes.

The PN code is used as the sequence to enable the WUR to process the remainder of the WUR packet. Currently the WUR preamble (also known as a PN sequence) uses a known sequence for detection/activation. This PN sequence is extended in accordance with an exemplary embodiment to a set of codes/sequences, with two code sequences shown as an example in the Figure. However, any number of code sequences could be used. The codes used could either be orthogonal or have good correlation properties affording good detection probability. The examples of code could be a Walsh Code, a PN code, or the like. A search program could also be developed to locate random codes with the desired properties. The specific code type is not a limitation of the concepts disclosed herein and additional and/or alternative code types could be used with similar success. The WUR packet further includes a Receiver ID, an Action field and a FCS, with these fields capable of each being any length.

Thus, the WUR would correlate against a few codes to discern which code is being used, if any. The number of codes could optionally be limited to minimize the cost in the receiver. While an exemplary embodiment will be described in relation to a 4 code embodiment, this is not a limiting aspect of the concept as any number of codes could be used.

The code that any particular WUR device would use can be assigned, for example, by the network and conveyed during association as one example. Thus, a network could assign one code for all Wi-Fi devices, one for all ZigBee devices, and so on. Then, a WUR, with a Wi-Fi device's companion main radio, would only activate when that code was sent with all Wi-Fi devices being required to demodulate the remaining portion of the WUR packet.

Having the code as part of the WUR preamble reduces the overhead of adding additional signalling in the WU packet. Additionally, the WUR devices could save power for cases where the code sent is not for them but for other class(es) or types of devices. When a different code than that which was assigned to the device is used, the WUR can avoid processing the remaining portion of the WU packet since that packet is not intended for that device. This can further improve device power consumption.

Another embodiment allows for a flexible WUR payload based on the preamble code. For example, if one code was used for Wi-Fi, another code for Bluetooth®, etc., then for all Wi-Fi devices the WUR payload could be optimized for that use. Then, for the Bluetooth® code, the WUR payload can be defined differently to best use the BT devices. This also affords a coexistence benefit not currently possible. In the case of BT and Wi-Fi, since the WUR could be used to wake-up the companion BT radio, which could be in the same band as the Wi-Fi device, one additional advantage is that (interference) protection can be provided. In one embodiment, the WUR packet can have a legacy preamble which could be used to defer transmission by the Wi-Fi devices, and thus protect, the wake-up communication related to the BT.

The use could be also used to address a device type instead of technology. So one code could identify all security cameras, and another code could be used for all the light switches, etc. Thus, the WUR payload could provide data appropriate to a technology and/or device. This is shown in FIGS. 7-8.

In FIGS. 7-8 the WUR packet is configured differently after the legacy preamble portion. As one example shown in FIG. 7, a 30-bit code is used, and in the first case, Code 1 could identify the Wi-Fi devices where 16 bits for a Wi-Fi ID (partial MAC address) and 8 bits of Action plus an 8 bit CRC or FCS are needed.

In the second exemplary WUR packet as shown in FIG. 8, the 30-bit code is a second code (Code 2), which, in accordance with this exemplary embodiment, identifies Bluetooth® devices, with 5 bits for a Bluetooth® ID and 4-bit Action field plus 6 bit CRC/FCS. The exemplary payloads shown here are for purposes of illustrating the re-configurability of WUR packets, while the specific allocations used are not limiting.

Finally, an additionally benefit of this first approach of using different preamble codes is to allow the system the flexibility to wake more than one radio with one Wake-up packet. For instance, if the security system needs to wake two sensors for a report, a single WU packet can be used. Thus, to enable this feature, one code could be dedicated to that purpose, i.e., waking two sensors for a report. When the other code is used, the other code allows other WUR devices to be aware that the WUR packet is an aggregation of more than one type of device. Thus, if the code sent includes their type, the devices would decode the full WUR aggregated packet to attain their information. For instance, say there are 3 codes assigned for each technology. They are assigned as code 1=Wi-Fi devices, code 2=Bluetooth® devices and code 3=ZigBee devices. Then there would be additional codes to signify aggregation cases. For example, code 4 could signify that both Wi-Fi and Bluetooth WUR packets are aggregated into one packet. This is shown in FIG. 9 where a first portion 904 is the portion for the Wi-Fi device, and the second portion 908 is for the Bluetooth® device. This removes the need to send the legacy STF, Legacy LTF, and Legacy SIG (and perhaps even move legacy fields) for cases where more than one WUR needs to be activated. Having this ability improves network throughput by aggregating the signalling of two (or more) devices in one wake-up packet. This could also be used within a set of device types instead of technology types.

The second approach is to add additional signalling in the WU packet payload. In this approach, additional bit(s) would be added to the WU packet payload to identify which device to wake. In this second approach, an additional bit field would be added somewhere in the payload (after the Preamble code). The bit field should be kept to a small size to reduce system overhead. An exemplary embodiment is to assign 2 bits, allowing 4 categories, however any number is possible.

Additionally, and optionally, one way to also extend WUR packet aggregation as done in approach one to this second approach, is to have this new bit field be the first field in the payload. Thus, a WUR device could decode this field first to discern if this is an aggregation payload. To enable reliable decoding of this field, additional coding protection could be required for these bits (such as repetition), since decoding could happen without the aid of a CRC for check.

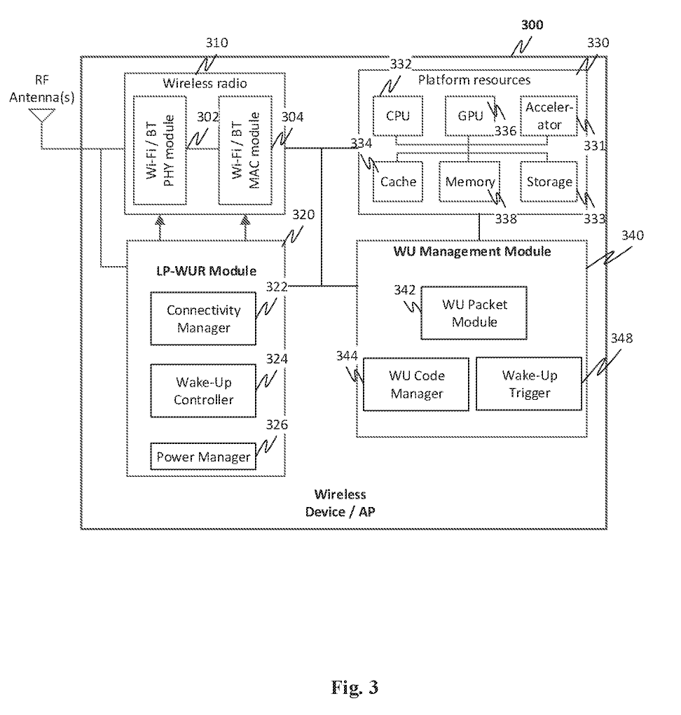

FIG. 3 illustrates an exemplary functional block diagram of a wireless device 300, such as an AP, mobile device, STA, IoT device, etc., that can be used with any one or more of the aspects disclosed herein. In particular, this exemplary architecture, where well-known components have been omitted for clarity, allows the LP-WUR module 320 to one or more of improve connectivity management and save power in the device 300 and optionally in one or more various platform resources 330.

More specifically, FIG. 3 illustrates an exemplary wireless/mobile device/AP 300 that includes a wireless radio 310, which includes a Wi-Fi/Bluetooth® (BT)/BLE PHY module 302, a Wi-Fi/BT/BLE MAC module 304, an LP-WUR module 320, and one or more interconnected platform resources 330, such as CPU 332, cache 334, GPU 336, memory 338, accelerator 331 and storage 333. Optionally, the device 300 could also include one or more other radios for any one or more other communications technologies, e.g., 4G, LTE, 5G, RFID, etc. Optionally, the LP-WUR module 320 may have its own demodulator, antenna, etc., to complement its low-power operation. The accelerator 331 can cooperate with MAC circuitry to, for example, perform real-time MAC functions. The GPU 336 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In addition, the wireless/mobile device 300 includes a connectivity manager 322, that manages a wake-up channel, a wake-up controller 324 that triggers a wake-up of a main radio, and a power manager 326 that manages power of the WU radio(s). The wireless/mobile device 300 also includes a WU management module 340 which includes a WU packet module 342, a WU code manager 344, and a wake-up trigger 348. The mobile device 300 can also include one or more sensors (not shown) such as an accelerometer, gyroscope, GPS, Wi-Fi location determination module, and in general any device(s) capable of determining a position or change in position of the device.

In accordance with one exemplary embodiment, the presence of the LP-WUR is leveraged to one or more of improve latency and reduce power consumption. More specifically, the LP-WUR module 320 maintains connectivity to, for example, an AP without waking up the main radio 310. The AP can transmit wake-up packets with partial beacon information to the associated stations equipped with LP-WURs. When the wake-up packets are periodically received, the station “knows” that the AP is still within transmission range. Otherwise, if the periodic wake-up packets are not received, the station “knows” or detects that the AP is outside of the transmission range with this information being communicable to the main wireless radio 310 by the wake-up controller 324 and connectivity manager 322. This allows the power manager 326 to keep the main radio 310 in a sleep state, or turned off, for a longer period of time and maximize the radio/platform power saving without risking disconnection from the AP for a longer period of time.

Upon receiving a wakeup packet at the device 300, the LP-WUR 320, wakes up the main radio(s) 310 (e.g., IEEE 802.11 radio/Bluetooth,® etc.) Once the main radio 310 is active, the LP-WUR 320 may be turned off to save power, and the device 300 can have a “normal” frame exchange with one or more other devices.

The WU management module 340 includes a WU packet module 342, a WU code manager 344 and a WU trigger 348. The WU packet module 342 assembles/encode and/or decodes WU packets in accordance with the packet structures disclosed herein. Similarly, the WU code manager can cooperate with the WU packet module to assemble/encode/decode/store any one or more of the codes or combinations of codes as disclosed herein. The WU trigger 340 is capable of reading a received packet and determining whether the packet is intended for device 300 (or an associated device) and activating the wake-up controller when it is determined that the main radio of device 300 should be awoken.

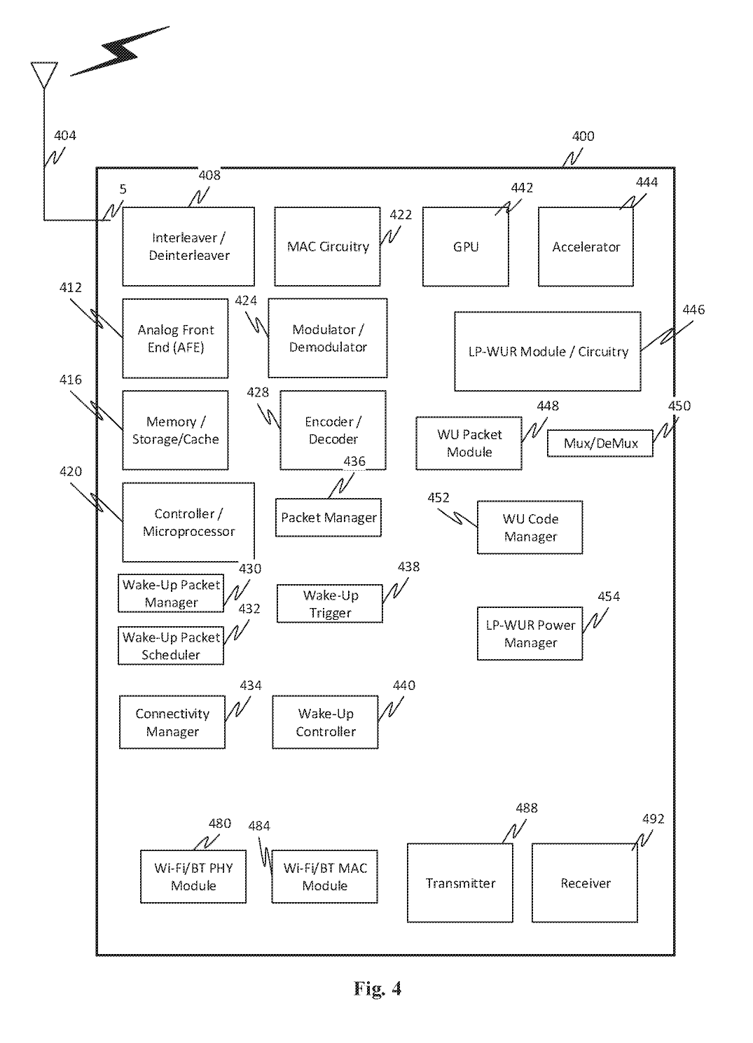

FIG. 4 illustrates an exemplary hardware diagram of a device 400, such as a wireless device, mobile device, access point, station, or the like, that is adapted to implement the technique(s) discussed herein. As with FIG. 3, operation will be discussed in relation to the components in FIG. 4 appreciating that each separate device, e.g., station, AP, proxy server, etc., can include one or more of the components shown in the figure, with the components each being optional.

In addition to well-known componentry (which has been omitted for clarity), the device 400 includes interconnected elements (with links 5 omitted for clarity) including one or more of: one or more antennas 404, an interleaver/deinterleaver 408, an analog front end (AFE) 412, memory/storage/cache 416, controller/microprocessor 420, MAC circuitry 422, modulator/demodulator 424, encoder/decoder 428, a wake-up packet manager 430, a wake-up packet scheduler 432, a connectivity manager 434, a packet manager 436, a WU trigger 438, a wake-up controller 440, GPU 442, accelerator 444, a LP-WUR module and/or circuitry 446, a WU packet module 448, a multiplexer/demultiplexer 450, a WU code manager 452, a LP-WUR power manager (not shown), and wireless radio 310 components such as a Wi-Fi/BT/BLE PHY module 480, a Wi-Fi/BT/BLE MAC module 484, transmitter 488 and receiver 492. The various elements in the device 400 are connected by one or more links (not shown, again for sake of clarity). As one example, the wake-up packet manager 430, the wake-up packet scheduler 432, the connectivity manager 434, the packet manager 436, the WU trigger 438 and the wake-up controller 44 can be embodied as process(es) executing on a processor or controller, such as processor 1120 with the cooperation of the memory 1116. The components could also be embodied in one or more ASICs and/or as part of a system on a chip.

The device 400 can have one more antennas 404, for use in wireless communications such as multi-input multi-output (MIMO) communications, multi-user multi-input multi-output (MU-MIMO) communications Bluetooth®, LTE, RFID, 4G, LTE, etc. The antenna(s) 404 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 404 generally interact with the Analog Front End (AFE) 412, which is needed to enable the correct processing of the received modulated signal and signal conditioning for a transmitted signal. The AFE 412 can be functionally located between the antenna and a digital baseband system in order to convert the analog signal into a digital signal for processing and vice-versa.

The device 400 can also include a controller/microprocessor 420 and a memory/storage/cache 416. The device 400 can interact with the memory/storage/cache 416 which may store information and operations necessary for configuring and transmitting or receiving the information described herein. The memory/storage/cache 416 may also be used in connection with the execution of application programming or instructions by the controller/microprocessor 420, and for temporary or long term storage of program instructions and/or data. As examples, the memory/storage/cache 420 may comprise a computer-readable device, RAM, ROM, DRAM, SDRAM, and/or other storage device(s) and media.

The controller/microprocessor 420 may comprise a general purpose programmable processor or controller for executing application programming or instructions related to the device 400. Furthermore, the controller/microprocessor 420 can perform operations for configuring and transmitting information as described herein. The controller/microprocessor 420 may include multiple processor cores, and/or implement multiple virtual processors. Optionally, the controller/microprocessor 420 may include multiple physical processors. By way of example, the controller/microprocessor 420 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 400 can further include a transmitter 488 and receiver 492 which can transmit and receive signals, respectively, to and from other wireless devices and/or access points using the one or more antennas 404. Included in the device 400 circuitry is the medium access control or MAC Circuitry 422. MAC circuitry 422 provides for controlling access to the wireless medium. In an exemplary embodiment, the MAC circuitry 422 may be arranged to contend for the wireless medium and configure frames or packets for communicating over the wireless medium.

The PHY Module/Circuitry 1156 controls the electrical and physical specifications for device 1100. In particular, PHY Module/Circuitry 1156 manages the relationship between the device 1100 and a transmission medium. Primary functions and services performed by the physical layer, and in particular the PHY Module/Circuitry 1156, include the establishment and termination of a connection to a communications medium, and participation in the various process and technologies where communication resources shared between, for example, among multiple STAs/APs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 1156 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 1122 handle co-ordination of interactions between the MAC and PHY layers.

The interleaver/deinterleaver 1108 cooperates with the various PHY components to provide Forward Error correction capabilities. The modulator/demodulator 1124 similarly cooperates with the various PHY components to perform modulation which in general is a process of varying one or more properties of a periodic waveform, referred to and known as a carrier signal, with a modulating signal that typically contains information for transmission. The encoder/decoder 1128 manages the encoding/decoding used with the various transmission and reception elements in device 1100.

The MAC layer and components, and in particular the MAC module 1160 and MAC circuitry 1122 provide functional and procedural means to transfer data between network entities and to detect and possibly correct errors that may occur in the physical layer. The MAC module 1160 and MAC circuitry 1122 also provide access to contention-based and contention-free traffic on different types of physical layers, such as when multiple communications technologies are incorporated into the device 1100. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 400 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 4, the exemplary device 400 also includes a GPU 442, an accelerator 444, a LP-WUR module and/or circuitry 446 a Wi-Fi/BT/BLE PHY module 480 and a Wi-Fi/BT/BLE MAC module 484 that at least cooperate with the LP-WUR module 446 and one or more of mux/demux 450, wake-up packet manager 430, wake-up packet scheduler 432, connectivity manager 434, packet manager 436, WU packet module 448, WU code manager 452, WU trigger 438 and WU controller 440 to achieve at least the more efficient operation as discussed herein. Assume an Access Point (AP) transmits a wake-up packet to a W-Fi/BT Station (STA), which is equipped with WUR: then AP is acting as a transmitter and should include the packet scheduler 432. However, on the STA side, where the STA is acting in a receiver capacity, the STA may or may not include the scheduler 432 and other related component(s).

In accordance with an exemplary operational embodiment, the device 400, acting in a transmitting capacity (e.g., acting as a transmitting AP), the wake-up packet module 448 determines which device, groups of devices and/or classes of devices should be awoken. Cooperating with the wake-up code manager 452, and packet manager 436 a packet is assembled with the appropriate codes to wake-up the device, groups of devices and/or classes of devices as discussed herein and in relation to FIGS. 5-9. This packet(s) is then transmitted with the cooperation of the transmitter 488.

The device 400, acting in a receiving capacity, upon receipt of this packet at by the wake-up radio 446 and wake-up packet manager, utilizes the wake-up packet module and wake-up code manager to determine the device(s), groups of devices and/or classes of devices to be awoken based on the information in the wake-up payload as described in relation to FIGS. 5-9 and as described herein. The identified device(s) are then woken-up with the cooperation of the wake-up trigger and wake-up controller 400.

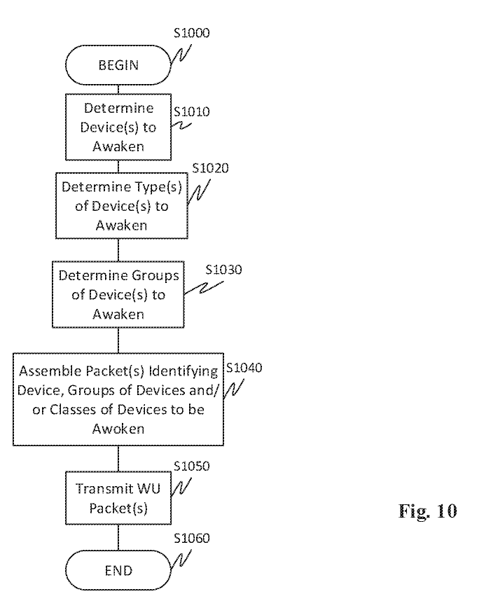

FIG. 10 outlines an exemplary technique for enhancing wake-up radio operation. Control begins in step S1000 and continues to step S1010. In step S1010, a determination is made as to which device(s) to awaken. Next, alternatively or additionally, in step S1020, a determination is made as to which type(s) of device(s) to awaken. Next, alternatively or additionally, in step S1030, a determination is made as to which group(s)/classes of device(s) to awaken. Then, in step S1040, one or more packets are assembled as described herein as wake-up packets. Control then continues to step S1060.

In step S1060, and upon completion of the assembly of the packet(s), the packets are transmitted. Control then continues to step S1060 where the control sequence ends.

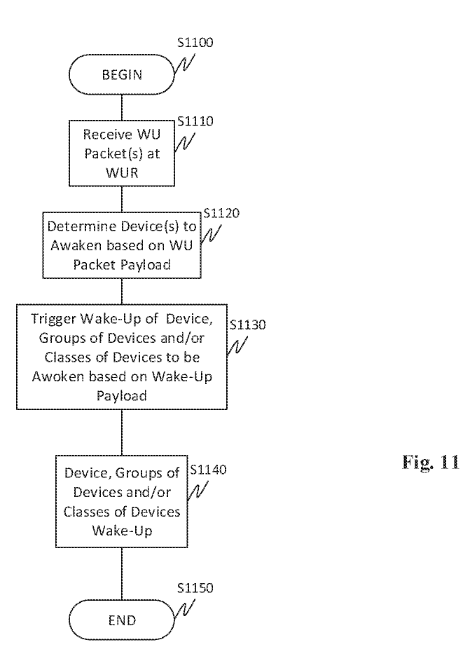

FIG. 11 outlines an exemplary receiver-side technique for enhancing wake-up radio operation. For example, this operation can be performed by the master wake-up radio as described herein. In particular control begins in step S1100 and continues to step S1110. In step S1110, the wake-up packet is received at a wake-up radio. Next, in step S1120, a determination is made as to which devices to awaken based on the wake-up packet payload or a code received in the preamble. Then, in step S1130, triggering of the wake-up of the device, groups of devices and/or classes of devices to be awoken based on wake-up payload or the code in the preamble is performed. Control then passes to step S1140.

In step S1140, the identified device, groups of devices and/or classes of devices to be awoken are awoken with control continuing to step S1150 where the control sequence ends.

It should also be appreciated that the techniques disclosed herein can be extended to Neighbor awareness networks (NAN) which allow wireless devices in near proximity to perform data exchanges directly over the NAN (e.g., without requiring the use of wireless carriers, Wi-Fi access points, other networks, etc.). The data exchange between the wireless devices in the NAN can occur through use of a wireless network that employs one or more IEEE 802.11 protocols. For example, a NAN using specific IEEE 802.11 protocols (such as IEEE 802.11a, IEEE 802.11b, IEEE 802.11g, IEEE 802.11n, IEEE 802.11ac, IEEE 802.11ad, IEEE 802.11ax, etc.) may support data transfer over one or more of a 2.4 GHz or 5 GHz frequency band.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:
a wake-up code manager to select one or more codes corresponding to a group or class of devices to be awoken; and
a wake-up packet module, wake up packet manager and connected transmitter to assemble and transmit a wake-up packet, the wake-up packet usable by respective low power wake-up radios to wake-up respective groups or classes of devices.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.
Any of the above aspects, wherein the one or more codes are part of a wake-up preamble in a wake-up packet, the wake-up packet further including a payload.
A non-transitory information storage media having stored thereon one or more instructions, that when executed by one or more processors, cause a wireless device to perform a method comprising:
selecting one or more codes corresponding to a group or class of devices to be awoken; and
assembling and transmitting a wake-up packet, the wake-up packet usable by respective low power wake-up radios to wake-up respective groups or classes of devices.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.

A wireless communications device comprising:
means for selecting one or more codes corresponding to a group or class of devices to be awoken; and
means for assembling and transmitting a wake-up packet, the wake-up packet usable by respective low power wake-up radios to wake-up respective groups or classes of devices.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.
Any of the above aspects, wherein the one or more codes are part of a wake-up preamble in a wake-up packet, the wake-up packet further including a payload.

A wireless communications device comprising:
a wake-up radio to receive a wake-up packet, the wake-up packet identifying one or more devices, groups or classes of devices to awaken;
a wake-up packet module and wake-up code manager to determine the one or more devices, groups and/or classes of devices to be awoken based on the information in a wake-up packet payload; and
a wake-up controller to awaken the determined the one or more devices, groups and/or classes of devices to be awoken based on the information in a wake-up packet payload. Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.
Any of the above aspects, wherein the one or more codes are part of a wake-up preamble in a wake-up packet, the wake-up packet further including a payload.

A wireless communications device comprising:
means for receiving a wake-up packet, the wake-up packet identifying one or more devices, groups or classes of devices to awaken;
means for determining the one or more devices, groups and/or classes of devices to be awoken based on the information in a wake-up packet payload; and
means for awakening the determined the one or more devices, groups and/or classes of devices to be awoken based on the information in a wake-up packet payload.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.
Any of the above aspects, wherein the one or more codes are part of a wake-up preamble in a wake-up packet, the wake-up packet further including a payload.

A method of operating a wireless access point comprising:
selecting one or more codes corresponding to a group or class of devices to be awoken; and
assembling and transmitting a wake-up packet, the wake-up packet usable by respective low power wake-up radios to wake-up respective groups or classes of devices.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.

A method of operating a wireless access station comprising:
receiving a wake-up packet, the wake-up packet identifying one or more devices, groups or classes of devices to awaken;
determining the one or more devices, groups and/or classes of devices to be awoken based on the information in a wake-up packet payload; and
awakening the determined the one or more devices, groups and/or classes of devices to be awoken based on the information in a wake-up packet payload.
Any of the above aspects, wherein the wake-up packet includes one or more of: a Media Access Control address, an identifier, and an action field.
Any of the above aspects, wherein the identifier is a receiver identifier, a Wi-Fi identifier, a Bluetooth identifier or an RFID identifier.
Any of the above aspects, wherein the wake-up packet further includes an action field.
Any of the above aspects, wherein the wake-up packet further includes one or more legacy fields.
Any of the above aspects, wherein the one or more codes are a WUR packet preamble.
Any of the above aspects, wherein the groups or classes of devices are grouped or classified based on any one or more of: a communication protocol, a device type, a device location, a device identification, a device function, and/or a wake-up channel.
Any of the above aspects, further comprising a low-power wake-up radio power manager configured to control operation of a low-power wake-up radio.
Any of the above aspects, configured to one or more of save power and improve connectivity.
Any of the above aspects, wherein the one or more codes are part of a wake-up preamble in a wake-up packet, the wake-up packet further including a payload.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications and power consumption reduction. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a wake-up code manager to select one or more codes corresponding to a group or class of devices to be awoken; and
a wake-up packet module, wake up packet manager and connected transmitter to assemble and transmit a wake-up packet, the wake-up packet usable by respective low power wake-up radios to wake-up respective groups or classes of devices based on the one or more codes corresponding to the group or class of devices to be awoken.

2. The device of claim 1, wherein the wake-up packet includes one or more of: a Media Access Control address, an identifier, and an action field.

3. The device of claim 2, wherein the identifier is a receiver identifier, a Wi-Fi identifier, a Bluetooth identifier or an RFID identifier.

4. The device of claim 2, wherein the wake-up packet further includes an action field.

5. The device of claim 2, wherein the wake-up packet further includes one or more legacy fields.

6. The device of claim 1, wherein the one or more codes are a WUR packet preamble.

7. The device of claim 1, wherein the groups or classes of devices are grouped or classified based on any one or more of: a communication protocol, a device type, a device location, a device identification, a device function, and/or a wake-up channel.

8. The device of claim 1, further comprising a low-power wake-up radio power manager configured to control operation of a low-power wake-up radio.

9. The device of claim 1, configured to one or more of save power and improve connectivity.

10. The device of claim 1, wherein the one or more codes are part of a wake-up preamble in a wake-up packet, the wake-up packet further including a payload.

11. A non-transitory information storage media having stored thereon one or more instructions, that when executed by one or more processors, cause a wireless device to perform a method comprising:
selecting one or more codes corresponding to a group or class of devices to be awoken; and
assembling and transmitting a wake-up packet, the wake-up packet usable by respective low power wake-up radios to wake-up respective groups or classes of devices based on the one or more codes corresponding to the group or class of devices to be awoken.

12. The media of claim 11, wherein the wake-up packet includes one or more of: a Media Access Control address, an identifier, and an action field.

13. The media of claim 12, wherein the identifier is a receiver identifier, a Wi-Fi identifier, a Bluetooth identifier or an RFID identifier.

14. The media of claim 12, wherein the wake-up packet further includes an action field.

15. The media of claim 12, wherein the wake-up packet further includes one or more legacy fields.

16. The media of claim 12, wherein the one or more codes are a WUR packet preamble.

17. The media of claim 11, wherein the groups or classes of devices are grouped or classified based on any one or more of: a communication protocol, a device type, a device location, a device identification, a device function, and/or a wake-up channel.

18. The media of claim 11, further comprising a low-power wake-up radio power manager configured to control operation of a low-power wake-up radio.

19. The media of claim 11, configured to one or more of save power and improve connectivity.

20. A wireless communications device comprising:
means for selecting one or more codes corresponding to a group or class of devices to be awoken; and
means for assembling and transmitting a wake-up packet, the wake-up packet usable by respective low power wake-up radios to wake-up respective groups or classes of devices based on the one or more codes corresponding to the group or class of devices to be awoken.

21. A wireless communications device comprising:
a wake-up radio to receive a wake-up packet, the wake-up packet identifying one or more devices, groups or classes of devices to awaken;
a wake-up packet module and wake-up code manager to determine the one or more devices, groups and/or classes of devices to be awoken based on the information in a wake-up packet payload; and
a wake-up controller to awaken the determined the one or more devices, groups and/or classes of devices to be awoken based on the information in a wake-up packet payload.
